(19) United States
(12) Patent Application Publication
(10) Pub. No.: US 2024/0353741 A1
(43) Pub. Date: Oct. 24, 2024

(54) IMAGE PICKUP APPARATUS IN WHICH CONDENSATION ON OPTICAL ELEMENT IS SUPPRESSED

(71) Applicant: CANON KABUSHIKI KAISHA, Tokyo (JP)

(72) Inventors: HIROTSUGU NAKAYAMA, Kanagawa (JP); HARUKA KOBAYASHI, Kanagawa (JP)

(21) Appl. No.: 18/633,900

(22) Filed: Apr. 12, 2024

(30) Foreign Application Priority Data
Apr. 20, 2023 (JP) 2023-069176

(51) Int. Cl. G03B 17/55

(52) U.S. Cl. CPC G03B 17/55

(57) ABSTRACT

An image pickup apparatus that appropriately suppresses condensation on an optical element therein. The image pickup apparatus comprising an optical element, a heat generation source of which a heat generation amount can be controlled, a holding member configured to hold the optical element, and a heat transfer member having a thermal conductivity higher than a thermal conductivity of the holding member, and configured to transfer a heat of the heat generation source to the optical element.

### BACKGROUND OF THE INVENTION

### Field of the Invention

The present invention relates to an image pickup apparatus in which condensation on an optical element is suppressed.

### Description of the Related Art

In a general image pickup apparatus, an exterior is formed by an exterior member and some optical elements, and other optical elements, image pickup devices, and the like are contained in the exterior. This structure may cause condensation because of an increasing temperature difference between the inside and the outside of the image pickup apparatus due to heat generation of an image pickup device and/or the like and/or depending on a use environment of the image pickup apparatus. In particular, when the condensation is generated on the optical element, there is a possibility that visibility of an object is lowered and/or a captured image is deteriorated.

Therefore, Japanese Laid-Open Patent Publication (kokai) No. 2017-198768 discloses a method for transferring heat from an electric component generating heat at the time of shooting (mainly a CPU and an image pickup device) to an eyepiece lens by a heat transfer component, in order to suppress the condensation generated on the eyepiece lens, which is an optical element forming a portion of the exterior. With this method, it is possible to reduce the temperature difference between the optical element forming a portion of the exterior and an outside air and to suppress the condensation generated on the optical element.

In the technique of Japanese Laid-Open Patent Publication (kokai) No. 2017-198768, however, an effect of suppressing the condensation may be insufficient depending on a heat generation amount of a heat generation source and/or an external environment. In addition, if a configuration in which the optical element forming the exterior is heated by heat of the heat generation source is adopted, an atmosphere inside the housing is further heated by this configuration. When the temperature of the atmosphere increases, the condensation may be generated on the optical element contained in the exterior of the image pickup apparatus.

### SUMMARY OF THE INVENTION

The present invention provides an image pickup apparatus that appropriately suppresses condensation on an optical element therein.

Accordingly, the present invention provides an image pickup apparatus comprising an optical element, a heat generation source of which a heat generation amount can be controlled, a holding member configured to hold the optical element, and a heat transfer member having a thermal conductivity higher than a thermal conductivity of the holding member, and configured to transfer a heat of the heat generation source to the optical element.

According to the present invention, the condensation on the optical element of the image pickup apparatus can be appropriately suppressed.

Further features of the present invention will become apparent from the following description of exemplary embodiments with reference to the attached drawings.

### BRIEF DESCRIPTION OF THE DRAWINGS

FIGS. 1A to 1C are a front perspective view, a rear perspective view, and a bottom view of a camera, respectively.

FIG. 2 is a front exploded perspective view of the camera.

FIG. 3A is a front exploded perspective view of an internal structural unit, and FIG. 3B is a front exploded perspective view of a main base unit.

FIG. 4A is a front perspective view of a lens barrel unit, and FIG. 4B is a front exploded perspective view of the lens barrel unit.

FIG. 5 is a rear perspective view of a diaphragm unit.

FIG. 6 is a view of a second group lens barrel as viewed from the +Z side.

FIG. 7 is a view of a second group lens barrel to which a diaphragm unit is assembled, as viewed from the +Z side.

FIG. 8A is a cross-sectional view taken along the line A-A in FIG. 7, and FIGS. 8B and 8C are cross-sectional views taken along the line B-B in FIG. 7.

FIG. 9 is a block diagram of main components of the camera for implementing a heat generation amount control processing.

FIG. 10 is a flowchart showing the heat generation amount control processing.

FIG. 11 is a rear perspective view of a front surface cover.

FIG. 12 is a rear exploded perspective view of the front surface cover.

### DESCRIPTION OF THE EMBODIMENTS

The present invention will now be described in detail below with reference to the accompanying drawings showing embodiments thereof.

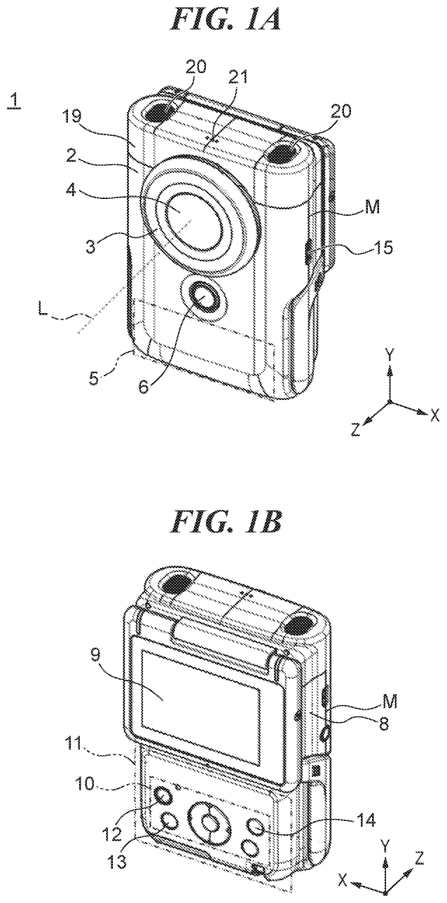

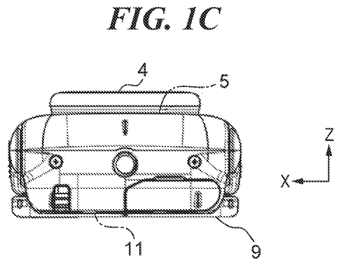

FIGS. 1A to 1C are perspective views of an image pickup apparatus according to an embodiment of the present invention. In the present embodiment, a camera 1 is exemplified as the image pickup apparatus. A camera 1 is, for example, a digital camera. An imaging optical axis of the camera 1 is referred to as an “optical axis L”.

For convenience, directions of the respective units will be referred to as follows with reference to X, Y, and Z coordinate axes. In a direction parallel to the optical axis L (Z direction), an object side is referred to as a front direction. Therefore, a +Y direction is an upward direction, and a +Z direction is the front direction. The +X direction is a left direction as viewed from a photographer (user) (a right direction as viewed from the object side), and is defined as “left (direction)” used in the description. Therefore, FIG. 1A is a front perspective view of the camera 1. FIG. 1B is a rear perspective view of the camera 1. FIG. 1C is a bottom view of the camera 1.

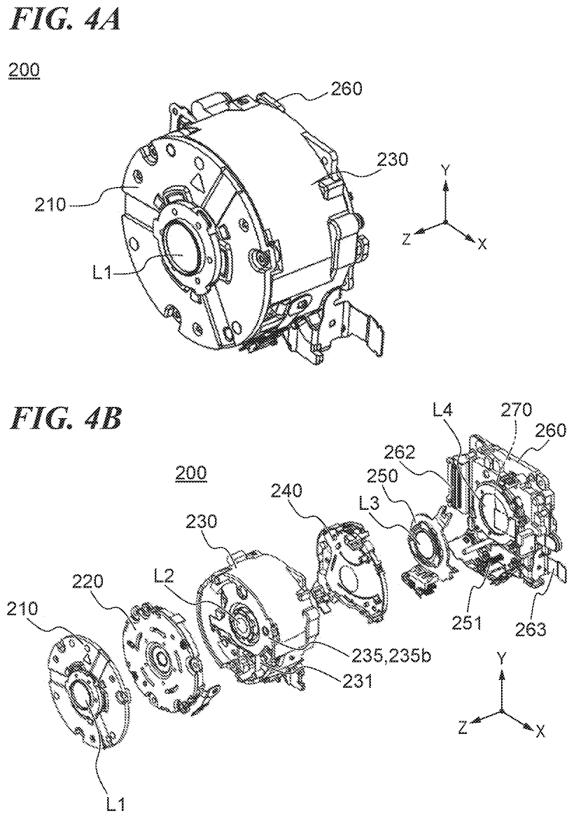

A lens barrel unit (lens barrel) 200 including an imaging optical system is disposed in front portion of the camera 1 (FIGS. 4A and 4B). The appearance of a front surface of the camera 1 is formed by a front surface cover 2. On an outer periphery of the lens barrel unit 200, a front surface ring 3 protruding toward the +Z side from the front surface cover 2 is provided.

The front surface ring 3 is provided with a protective glass 4. The protective glass 4 is an optical element that is located on a most object side among the components of the camera 1, and constitutes a portion of an exterior of the camera 1 or is exposed from the exterior. The protective glass 4 protects a lens inside the camera 1 from adhesion of dirt and dust, scratches, and the like.

On the −Y side of the front surface ring 3, a front surface grip area 5 is provided to be gripped by the user when the user holds the camera 1. A start/stop button 6 is disposed at the +Y side from the front surface grip area 5. Shooting starts when the start/stop button 6 is pressed, and the shooting finishes when the start/stop button is pressed again.

An appearance of a back surface of the camera 1 is formed by a back surface cover 8. A display unit 9 and a back surface operation member 10 are provided on the back surface side of the camera 1. An image signal of an object image captured by an image pickup device 270 (FIG. 4B) is transmitted to the display unit 9, and a through image is displayed on the display unit 9. On the −Y side of the display unit 9, a back surface grip area 11 which is gripped by the user when the user holds the camera 1 is provided.

An appearance of a top portion of the camera 1 is formed by a top surface cover 19. Microphone holes 20 for microphones, which are symmetrically disposed on both sides about the optical axis L of the lens barrel unit 200, and speaker holes 21 for speaker, which are symmetrically disposed on both sides about the optical axis L of the lens barrel unit 200, are provided on the top surface of the top surface cover 19. The speaker playbacks an operation sound and a sound of a captured moving image. Since the microphone holes 20 are located on the top surface of the camera 1, it is possible to reduce a difference in sound collection performance when the sound arrived from the front side (+Z side) and the sound arrived from the back side (−Z side) of the camera 1 are collected.

The back surface operation member 10 is disposed in a position on the −Y side in the back surface grip area 11. The back surface operation member 10 includes a power button 12, a playback button 13, a mode switching button 14, and the like. When the power button 12 is operated, the power of the camera 1 is switched on/off. When the playback button 13 is operated, the recorded captured image is displayed on the display unit 9.

The camera 1 have a plurality of shooting modes, and the user can switch the shooting modes by operating the mode switching button 14. Examples of the switchable shooting mode include a still image mode for shooting a still image, a moving image mode for shooting a moving image, and an image processing mode for performing digital processing on a captured image simultaneously with shooting.

An appearance of side surfaces of the camera 1 is formed by the front surface cover 2 and the back surface cover 8. Terminals, such as a USB terminal 15 and the like, are disposed at a position M where the front surface cover 2 and the back surface cover 8 are connected in the Z direction. The USB terminal 15 supplies power and transfers data to an external apparatus.

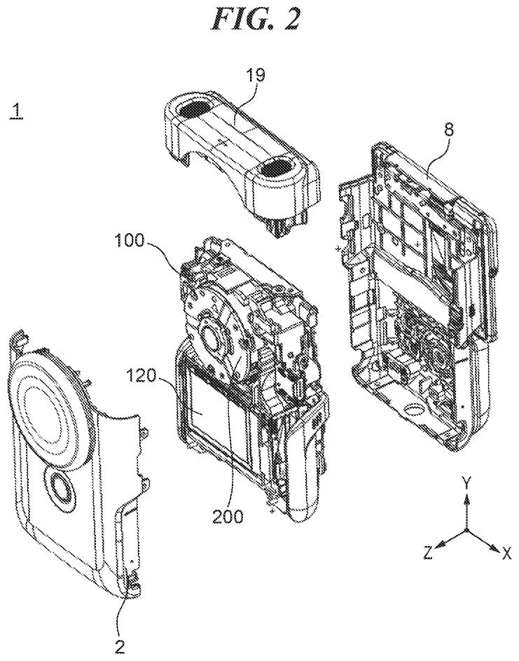

FIG. 2 is a front exploded perspective view of the camera 1. The exterior of the camera 1 includes mainly the front surface cover 2, the back surface cover 8, and the top surface cover 19. An internal structural unit 100 and the lens barrel unit 200 are contained in the exterior. A battery 120 is housed in the internal structural unit 100.

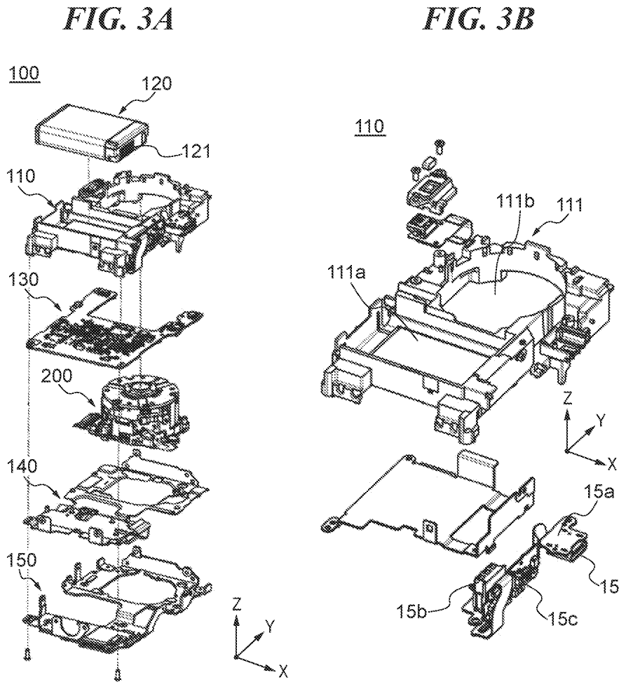

FIG. 3A is a front exploded perspective view of the internal structural unit 100. The lens barrel unit 200, the battery 120, a main substrate 130, a back surface heat sink unit 140, and a main chassis unit 150 are assembled to a main base unit 110, thereby configuring the internal structural unit 100.

FIG. 3B is a front exploded perspective view of the main base unit 110. The main base unit 110 includes a main base 111 as a base component. The main base 111 is formed with a battery chamber 111a, which is a space in which battery 120 is housed and held, and a barrel chamber 111b, which is a space in which the lens barrel unit 200 is housed and held.

As illustrated in FIG. 3B, a USB terminal 15 is disposed on an outer periphery of the barrel chamber 111b.

The USB terminal 15 is connected to the main substrate 130 via a USB flexible substrate 15a. The USB flexible substrate 15a has a battery terminal 15b electrically connected to the battery 120 and a power supply circuit area 15c on which elements related to a power supply circuit such as a charging IC, and the like, is mounted.

The power supply circuit area 15c includes a battery detection circuit, a switch circuit for switching energization blocks, and the like (none of them are illustrated). The power supply circuit area 15c detects whether or not the battery is mounted, a type of the battery, a remaining battery level (remaining capacity), and the like. The battery 120 is provided with a contact portion 121 connected to the battery terminal 15b (FIG. 3A).

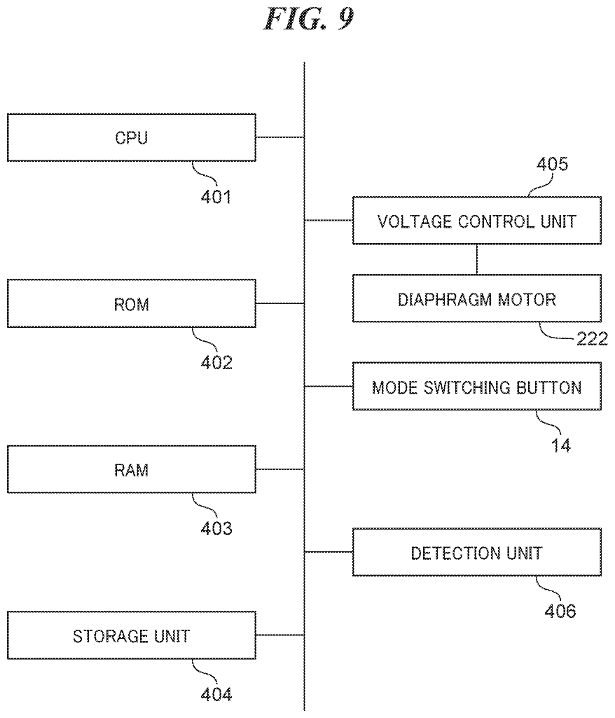

The main substrate 130 is fixed to the main base 111. The main substrate 130 includes, for example, a CPU 401 (FIG. 9), an electrical element, and terminals for electrically connecting the flexible substrates with each other. The battery 120 and the main substrate 130 may generate heat due to a shooting operation, a processing by the CPU 401 accompanying the shooting operation, and the like, which may increase their temperature high level. The imaging optical system, a shutter mechanism, a focus mechanism, and the like are disposed inside the lens barrel unit 200.

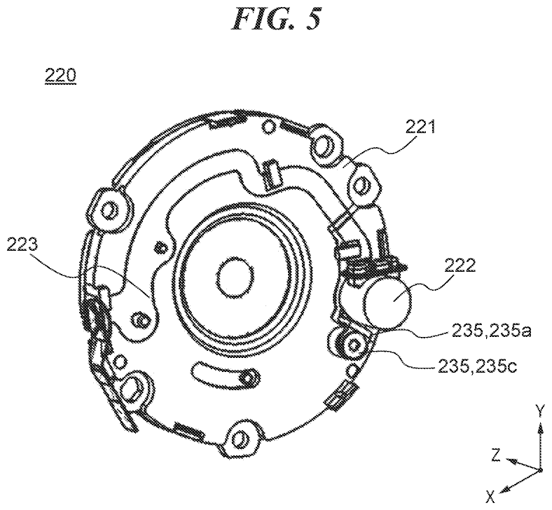

Next, an internal configuration of the lens barrel unit 200 will be described with reference to FIGS. 4A, 4B, and 5. FIG. 4A is a front perspective view of the lens barrel unit 200. FIG. 4B is a front exploded perspective view of the lens barrel unit 200.

The lens barrel unit 200 includes a first group lens barrel 210, a second group lens barrel 230, a third group lens barrel 250, a diaphragm unit 220, an ND unit 240, a sensor unit 260, and the like. “ND” is an abbreviation of a Neutral Density. An exterior of the lens barrel unit 200 is formed by a first group lens L1, the first group lens barrel 210, the second group lens barrel 230, the sensor unit 260, and the like (FIG. 4A). The diaphragm unit 220, the ND unit 240, the third group lens barrel 250, a second group lens L2, a third group lens L3, a fourth group lens LA, and the like are contained in the exterior.

The first group lens barrel 210 holds the first group lens L1. The sensor unit 260 holds the image pickup device 270. The image pickup device 270 includes an image sensor such as a CCD or a CMOS.

FIG. 5 is a rear perspective view of the diaphragm unit 220. The diaphragm unit 220 includes a diaphragm mechanism (not illustrated) that holds a plurality of diaphragm blades, and a diaphragm base plate 221. A diaphragm motor 222 is assembled to the diaphragm base plate 221. The diaphragm motor 222 is provided with a diaphragm flexible printed substrate 223. The diaphragm motor 222 is connected to the main substrate 130 via a lens barrel flexible printed substrate 263 (FIG. 4B).

The main substrate 130 includes a control circuit such as the CPU 401 (see FIG. 9). In order to change an amount of light to be guided to the image pickup device 270, the CPU 401 controls the diaphragm motor 222 to drive the plurality of diaphragm blades to change an aperture diameter. Furthermore, in order to keep the amount of light to be guided to the image pickup device 270 constant, the CPU 401 performs holding energization for maintaining the aperture diameter of the diaphragm unit 220 constant. At this time, the diaphragm motor 222 generates heat by the energization.

In addition, the CPU 401 is capable of changing a heat generation amount of the diaphragm motor 222 by changing the voltage to be applied to the diaphragm motor 222. For example, the CPU 401 can control the amount of heat generated from the diaphragm motor 222 while maintaining the aperture diameter of the diaphragm unit 220 by controlling a value of the voltage to be applied in the holding energization. The diaphragm motor 222 is an example of a heat generation source of which a heat generation amount is capable of being controlled. For the purpose of enabling the heat generation amount to be controlled, an actuator that generates heat by the holding energization, for example, a stepping motor or a voice coil motor is suitable as the diaphragm motor 222; however, the diaphragm motor 222 is not limited thereto.

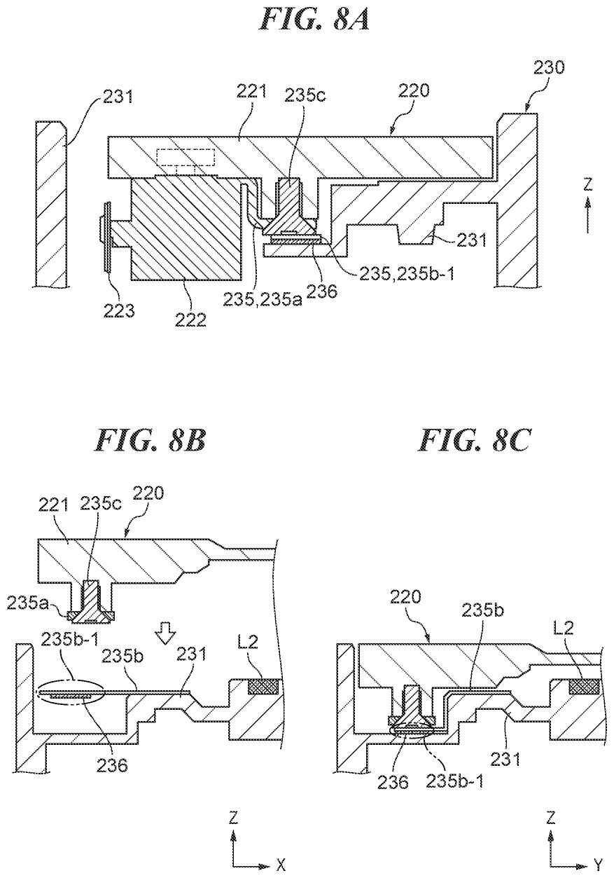

As illustrated in FIG. 4B, the second group lens barrel 230 includes a second group base plate 231. The second group base plate 231 is a holding member that holds the second group lens L2. In a vicinity of the second group lens L2, a heat transfer member 235 having higher thermal conductivity than that of the second group base plate 231 is disposed. As will be described in detail later in the description of FIGS. 8A to 8C, the heat transfer member 235 includes heat transfer elements 235a, 235b, and 235c. The heat transfer member 235 is disposed from the second group lens barrel 230 to the diaphragm unit 220.

The ND unit 240 is attached to the −Z side of the second group lens barrel 230. The ND unit 240 includes an ND filter and an ND driving unit (not illustrated). The ND filter is opened and closed by the driving force of the ND driving unit, and the amount of light to be guided to the image pickup device 270 is adjusted.

The third group lens barrel 250 holds the third group lens L3 constituting a focus lens. The third group lens barrel 250 moves in an optical axis direction by the driving force of a focus driving unit 251, thus the focusing operation is performed.

The sensor unit 260 holds the image pickup device 270 (as described above) and the fourth group lens LA, and is coupled to the second group lens barrel 230. The image pickup device 270 is connected to the main substrate 130 via the sensor flexible printed substrate 262. The image pickup device 270 photoelectrically converts an optical image of an object formed through a plurality of taking lenses constituting the imaging optical system to generate image data. There may be a case where the image pickup device 270 generates heat and has a high temperature according to the shooting operation. An inside of the camera 1 and an inside of the lens barrel unit 200 may be partially heated to a high temperature due to heat generation of the image pickup device 270, and/or the battery 120 and/or the main substrate 130 described above.

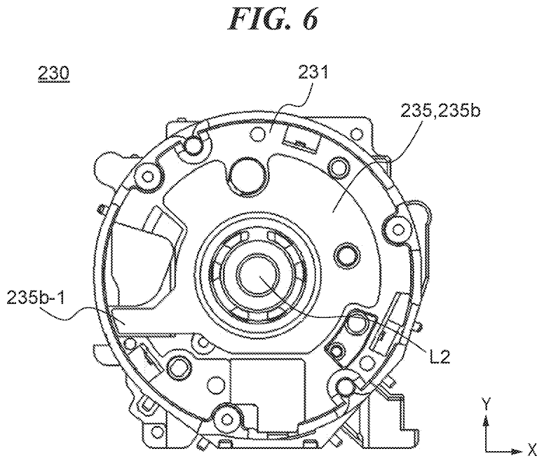

Next, a detailed configuration of the heat transfer member 235 will be described with reference to FIGS. 6, 7, and 8A to 8C.

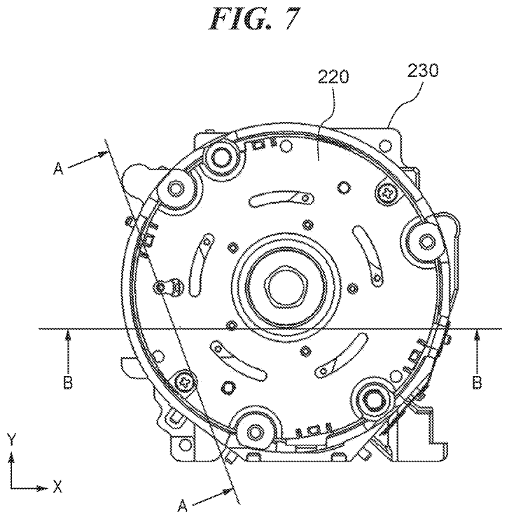

FIG. 6 is a view of the second group lens barrel 230 as viewed from the +Z side (first group lens barrel 210 side). FIG. 6 illustrates the second group lens barrel 230 before the diaphragm unit 220 is assembled. FIG. 7 is a view of the second group lens barrel 230 to which the diaphragm unit 220 is assembled, as viewed from the +Z side (first group lens barrel 210 side). FIG. 8A is a cross-sectional view taken along the line A-A in FIG. 7. FIGS. 8B and 8C are cross-sectional views taken along the line B-B in FIG. 7. FIG. 8B illustrates a state before the diaphragm unit 220 is assembled to the second group lens barrel 230. FIG. 8C illustrates a state after the diaphragm unit 220 is assembled to the second group lens barrel 230.

The heat transfer member 235 is disposed so as to transfer heat generated by the diaphragm motor 222 to the second group lens L2. As long as the heat transfer member 235 can transfer the heat of the diaphragm motor 222 to the second group lens L2, various shapes can be adopted to the heat transfer member 235.

In addition, the heat transfer member 235 may include a plurality of heat transfer elements. In the present embodiment, the heat transfer member 235 includes a first heat transfer element 235a, a second heat transfer element 235b, and a third heat transfer element 235c. A second heat transfer element arm portion 235b-1 is a portion of the second heat transfer element 235b. As illustrated in FIG. 8A, the first heat transfer element 235a is in contact with the diaphragm motor 222 and is thermally connected to the diaphragm motor 222. The second heat transfer element 235b is disposed in the vicinity of the second group lens L2. The second heat transfer element 235b is in contact with the second group base plate 231 of the second group lens barrel 230 in the vicinity of the second group lens L2, and is thermally connected to the second group lens L2. The third heat transfer element 235c, which is, for example, a steel screw, is in contact with both of the first heat transfer element 235a and the second heat transfer element 235b to thermally connect the first heat transfer element 235a with the second heat transfer element 235b.

In a state before the diaphragm unit 220 is assembled to the second group lens barrel 230 (FIG. 8B), the second heat transfer element 235b is held by the second group base plate 231 of the second group lens barrel 230. In addition, the first heat transfer element 235a and the third heat transfer element 235c are held by the diaphragm base plate 221 of the diaphragm unit 220.

As illustrated in FIG. 8A, the first heat transfer element 235a may include a portion connected to the diaphragm motor 222 and a portion fixed to a member holding the diaphragm motor 222. In the present embodiment, the first heat transfer element 235a has features of an outer shell and an exterior of the diaphragm motor 222 and a feature of a fixing portion of the diaphragm motor 222.

A portion of the first heat transfer element 235a is connected to the diaphragm motor 222, whereby the first heat transfer element 235a has the feature of the outer shell of the diaphragm motor 222. Another portion of the first heat transfer element 235a is fastened and fixed to the diaphragm base plate 221 by the third heat transfer element 235c. The diaphragm base plate 221 is a member that holds the diaphragm motor 222. The third heat transfer element 235c fixes the first heat transfer element 235a to the diaphragm base plate 221 while being in contact with the first heat transfer element 235a. The third heat transfer element 235c comes into contact with the second heat transfer element 235b when the diaphragm unit 220 is assembled to the second group lens barrel 230.

As described above, since the first heat transfer element 235a has the feature of the outer shell of the diaphragm motor 222 and the feature of the fixing portion of the motor 222 simultaneously, the lens barrel unit 200 (eventually, the camera 1) can be downsized and the number of components can be reduced. The first heat transfer element 235a is made of, for example, steel.

As illustrated in FIG. 6, the second heat transfer element 235b has a shape (annular shape) that goes around the second group lens L2 about the optical axis L. That is, the second heat transfer element 235b is a portion disposed so as to surround the periphery of the second group lens L2. With this arrangement, the heat is substantially uniformly transmitted to the second group lens L2 in a circumferential direction, and degradation of optical performance due to a temperature gradient in the second group lens L2 can be suppressed.

The second heat transfer element 235b is made of, for example, copper. As described above, the first heat transfer element 235a is made of, for example, the steel, and the third heat transfer element 235c is made of, for example, the steel. That is, the heat transfer member 235 is made of metal, and can have high thermal conductivity and high heat capacity. Therefore, the heat of the diaphragm motor 222 can be quickly transmitted, and the temperature of the second group lens L2 can be easily maintained even when an environmental temperature around the second group lens L2 rapidly decreases.

The second heat transfer element 235b is fixed to the second group base plate 231 with a double-sided tape or the like. Therefore, even when an impact is applied to the camera 1, positional displacement between the second heat transfer element 235b and the second group base plate 231 is less likely to occur. This fixing may be performed using a screw or adhesion instead of using the double-sided tape. From a viewpoint of substantially uniformly transferring heat in the circumferential direction of the second group lens L2 with a simpler configuration, the second heat transfer element 235b may have a uniform annular shape. Alternatively, a width of the second heat transfer element 235b in a radial direction may not be uniform from a viewpoint of securing a bonding area with the double-sided tape or the like. It should be noted that the shape of the second heat transfer element 235b may be a shape in which a portion of a circle is missing (missing circular shape).

The second heat transfer element 235b includes the second heat transfer element arm portion 235b-1 for a purpose of improving the assemblability of the diaphragm unit 220 to the second group lens barrel 230. As illustrated in FIGS. 8B and 8C, an elastic member 236 is provided on a surface (−Z-side surface) of the second heat transfer element arm portion 235b-1 facing the second group base plate 231. The elastic member 236 is fixed to the second heat transfer element arm portion 235b-1 with the double-sided tape or the like. Assembly of the diaphragm unit 220 to the second group lens barrel 230 will be described later.

It should be noted that the second heat transfer element 235b may also have other features similarly to the first heat transfer element 235a. For example, the second heat transfer element 235b may constitute a portion of the second group base plate 231 by insert molding. Alternatively, the second heat transfer element 235b may be configured as an optical thin film having enhanced heat conductivity in the second group lens L2.

Next, a method of assembling the diaphragm unit 220 to the second group base plate 231 of the second group lens barrel 230 will be described.

When the diaphragm unit 220 is assembled to the second group base plate 231, the diaphragm unit 220 is assembled such that a center of the second group lens L2 is positioned substantially at a center of the second heat transfer element 235b (that is, such that the center of second group lens L2 is located on the optical axis L). Specifically, the diaphragm unit 220 is assembled to the second group base plate 231 by providing a positioning portion on the second group base plate 231 or using an assembling tool.

The second heat transfer element 235b, including the second heat transfer element arm portion 235b-1, in a state before the diaphragm unit 220 is assembled to the second group base plate 231 has a planar shape (FIG. 8B). An operator assembles the diaphragm unit 220, to which the first heat transfer element 235a is fixed by the third heat transfer element 235c, from +Z side relative to the second group base plate 231 the −Z direction (FIGS. 8B and 8C).

When the diaphragm unit 220 is assembled to the second group base plate 231, the second heat transfer element arm portion 235b-1 is pushed by the third heat transfer element 235c and plastically deformed. As a result, the elastic member 236 comes into contact with the second group base plate 231 of the second group lens barrel 230 (FIG. 8C). A shape and a material capable of biasing the second heat transfer element arm portion 235b-1 toward the third heat transfer element 235c are adopted to the elastic member 236. Accordingly, reliability of contact between the first heat transfer element 235a and the second heat transfer element arm portion 235b-1 can be improved. It should be noted that the elastic member 236 as a biasing member only needs to be able to bias the two heat transfer elements (the second heat transfer element arm portion 235b-1 and the third heat transfer element 235c) in a direction in which they are in contact with each other. For example, other members such as a spring may be adopted as the elastic member 236.

It should be noted that the elastic member 236 may be fixed to the second group lens barrel 230. The fixing is not limited to fixing using the double-sided tape. For example, the elastic member 236 may be fixed to the second group lens barrel 230 with an adhesive or the like, or may be sandwiched and held between the second heat transfer element 235b and the second group base plate 231. It should be noted that the second heat transfer element arm portion 235b-1 may be subjected to processing such as scribing in advance in order to its further facilitate plastic deformation. It should be noted that the second heat transfer element 235b and the second heat transfer element arm portion 235b-1 only need to have shape that is easy to assemble, and do not necessarily have a substantially planar shape.

The heat of the diaphragm motor 222 is transferred, via the first heat transfer element 235a, the third heat transfer element 235c, and the second heat transfer element 235b, to the second group lens L2, which increases the temperature of the second group lens L2 and a periphery thereof. As a result, a temperature difference between the atmosphere inside the camera 1, which is heated to a high temperature by the heat generated by the image pickup device 270 and/or the main substrate 130, and the second group lens L2 is reduced, and thus condensation generated on the second group lens L2 can be suppressed. In addition, by using the diaphragm motor 222 which is an actuator as a heat generation source for suppressing the condensation, it is possible to increase the temperature of the second group lens L2 substantially sealed in the lens barrel unit 200 with a simple configuration without adding a component dedicated to heat generation.

In addition, by configuring the heat transfer member 235 with the plurality of heat transfer elements, that is, by combining materials having different heat capacities and/or different degrees of rigidity, it is easy to reduce the temperature gradient in the second group lens L2 and improve assembly workability.

Furthermore, the heat generation amount of the diaphragm motor 222 is changeable. As a result, by increasing the heat generation amount of the diaphragm motor 222, the temperature of the second group lens L2 can be increased more rapidly, and the condensation on the second group lens L2 can be suppressed more quickly. It should be noted that control can be performed so that the heat generation amount of the diaphragm motor 222 decreases in a case where the temperature of the second group lens L2 becomes sufficiently high.

It should be noted that a gap(s) may be provided between the first heat transfer element 235a and the diaphragm motor 222 and/or between the second heat transfer element 235b and the second group lens L2. As a result, for example, vibration caused by driving of the actuator and/or an external force by an impact applied to the camera 1 can be blocked/lightened.

When the diaphragm motor 222 generates the heat, power of the battery 120 is consumed. The camera 1 may have a feature to control the heat generation amount as described below in order to, while suppressing the condensation, suppress the power consumption to extend the capturable time of the camera 1. That is, the CPU 401 as a controller may control the heat generation amount of the diaphragm motor 222 as the heat generation source by a heat generation amount control processing described below.

FIG. 9 is a block diagram of main components of the camera 1 for implementing the heat generation amount control processing. The main substrate 130 includes the CPU 401, a ROM 402, a RAM 403, a storage unit 404, and a voltage control unit 405. A detection result of the operation on the mode switching button 14 (FIG. 1B) and a detection result by a detection unit 406 (controller) are sent to the CPU 401.

The ROM 402 stores a control program to be executed by the CPU 401. The RAM 403 provides a work area to be used when the CPU 401 executes the control program. The storage unit 404 is a nonvolatile memory, and stores various data, detection values, history information, and the like. The detection unit 406 has a function to obtain environment information and a function to detect a state of the diaphragm motor 222. In addition, the detection unit 406 includes the power supply circuit area 15c (FIG. 3B) described above, and also detects a remaining battery level, which is a remaining capacity of the battery 120 and/or a consumption amount (power consumption amount) of the battery. The environment information includes information on at least one of temperature, humidity, and atmospheric pressure. The temperature may include a temperature of the atmosphere around the second group lens L2 and a temperature of the second group lens L2. The humidity may include a humidity of the atmosphere around the second group lens L2. The voltage control unit 405 controls the voltage to be applied to the diaphragm motor 222 based on a command from the CPU 401.

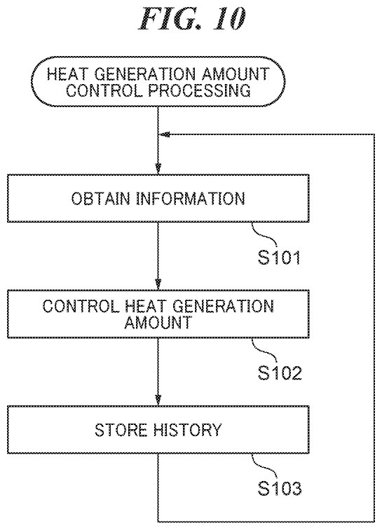

FIG. 10 is a flowchart showing the heat generation amount control processing. The heat generation amount control processing is implemented by the CPU 401 developing the control program stored in the ROM 402 into the RAM 403 and executing the control program. The heat generation amount control processing is started when the power of the camera 1 is turned on, and is ended when the power is turned off, for example.

In step S101, the CPU 401 obtains various types of information necessary for the heat generation amount control. For example, the CPU 401 obtains a shooting mode currently set in the camera 1. In addition, the CPU 401 may obtain the environment information, the remaining battery level, the history information stored in the storage unit 404, and the like. The history information is stored in step S103 (described later). The history information may include, for example, an execution history of each shooting mode and an obtainment history of the temperature and/or the humidity.

In step S102, the CPU 401 determines a voltage to be applied to the diaphragm motor 222 based on the obtained information, and transmits a command to the voltage control unit 405. As a result, the heat generation amount of the diaphragm motor 222 is controlled. Here, the processing is performed as follows.

First, the atmosphere inside the camera 1 becomes high temperature due to the heat generated by the image pickup device 270 and/or the main substrate 130. Therefore, a temperature to be reached and a rate of temperature increase of the atmosphere inside the camera 1 are different depending on the plurality of shooting modes provided in the camera 1. Therefore, the heat generation amount of the diaphragm motor 222 may be changed according to the shooting mode of the camera 1. Specifically, when the camera 1 is used in a shooting mode in which the image pickup device 270 and/or the main substrate 130 generate a large amount of heat, the CPU 401 performs control so that the heat generation amount of the diaphragm motor 222 becomes large (determines the voltage to be applied). On the other hand, when the camera 1 is used in a shooting mode in which heat generation is small, the CPU 401 performs control so that the heat generation amount of the diaphragm motor 222 becomes small.

The CPU 401 obtains the temperature and the humidity of the atmosphere around the second group lens L2 and the temperature of the second group lens L2, and determines a possibility of generation of the condensation. In a case where it is determined that the condensation is going to be generated, the CPU 401 performs control so that the heat generation amount of the diaphragm motor 222 becomes large. At this time, the temperature of second group lens L2 and the possibility of the generation of the condensation may be determined from the temperatures of the front surface ring 3 and/or the lens barrel unit 200 etc. without directly obtaining the temperature of the second group lens L2. In this case, the power supply of the camera 1 is not necessarily have to be on. For example, the CPU 401 may perform control so that the heat generation amount of the diaphragm motor 222 becomes large by detecting temperature change of the environment when, e.g., the camera 1 is moved from a cold environment to a warm environment.

The CPU 401 may control the heat generation amount of the diaphragm motor 222 according to the environment information and the shooting mode. For example, when the camera 1 is powered on, the CPU 401 may control the heat generation amount of the diaphragm motor 222 based on a temperature of a portion of the camera 1 close to an outside air and the shooting mode.

It should be noted that when the camera 1 is in a high temperature and high humidity environment for a long time, an amount of water vapor contained in the camera 1 increases, and the condensation is likely to occur. Therefore, the CPU 401 may control the heat generation amount of the diaphragm motor 222 according to the obtainment history of the environment information, or according to the obtainment history of the environment information and a current shooting mode. Although the environment information is desirably obtained by a plurality of thermohygrometers, it is sufficient if at least one thermohygrometer is provided. The CPU 401 may control the heat generation amount of the diaphragm motor 222 based on the atmospheric pressure in addition to the temperature or the humidity.

In addition, the CPU 401 may control the heat generation amount of the diaphragm motor 222 according to the execution history of the shooting mode. For example, in a case where there is a history of using the camera 1 for a certain period of time in a shooting mode in which the heat generation by the image pickup device 270 and/or the main substrate 130 is large, and the current shooting mode is a mode in which the heat generation is smaller than that in a previous shooting mode, the CPU 401 may control so that the heat generation amount of the diaphragm motor 222 becomes large.

Furthermore, the CPU 401 may control the heat generation amount of the diaphragm motor 222 according to the remaining battery level. Alternatively, the CPU 401 may control the heat generation amount of the diaphragm motor 222 according to the consumption amount of the battery in the shooting mode to be used. Alternatively, the CPU 401 may control the heat generation amount of the diaphragm motor 222 according to the remaining battery level and the consumption amount of the battery. The consumption amount of the battery may be obtained during shooting, or the consumption amount of the battery (power consumption amount) in each shooting mode may be stored in advance in the storage unit 404.

Specifically, the CPU 401 may calculate a remaining capturable time from the remaining battery level and the power consumption amount, and determine the possibility of generation of the condensation while taking the environment information into account. In a case where it is determined that condensation is going to generated within the remaining capturable time, the CPU 401 performs control so that the heat generation amount of the diaphragm motor 222 becomes large. In a case where it is determined that the condensation is not be generated within the remaining capturable time, the CPU 401 performs control so that the heat generation amount of the diaphragm motor 222 becomes small. The possibility of generation of the condensation is preferably calculated by time.

In addition, when the diaphragm motor 222 is heated at a certain temperature or higher for a long time, a diaphragm accuracy and/or durability may be deteriorated. In order to prevent such a situation, the CPU 401 may control the heat generation amount of the diaphragm motor 222 in accordance with the state of the diaphragm motor 222. For example, as a component that obtains the state of the diaphragm motor 222, a timer that measures a heat generation time of the diaphragm motor 222, a thermometer that detects the temperature of the diaphragm motor 222, an error detection unit that detects a control state of the diaphragm unit 220, and the like can be considered. In a configuration in which a threshold value(s) for each of the heat generation time, the temperature, and the control state are set, the CPU 401 reduces the heat generation amount of the diaphragm motor 222 or stops the heat generation, when an obtained value exceeds the corresponding threshold value. As a result, it is possible to suppress a decrease in the diaphragm accuracy and/or the durability.

As described above, it is determined whether or not the it is a situation in which condensation is likely to be generated, and the heat generation amount of the diaphragm motor 222 is controlled, which makes it possible to reduce the power consumption while suppressing the condensation, and extend the capturable time of the camera 1.

In step S103, the CPU 401 stores the history information regarding the shooting mode, the environment information and the like, in the storage unit 404, and returns to step S101.

It should be noted that the CPU 401 may obtain at least one piece of information in step S101, and control the heat generation amount of the diaphragm motor 222 in step S102 based on the at least one piece of information (e.g., shooting mode) obtained in step S101. In addition, the CPU 401 may control the heat generation amount of the diaphragm motor 222 based on two or more pieces of information (e.g., shooting mode information and temperature information). Therefore, information unnecessary for control does not need to be obtained, and does not need to be stored as the history information.

It should be noted that, in order to control the heat generation amount while taking the power consumption amount into account, it is desirable to heat the optical element using a heat generation source capable of changing the heat generation amount to an arbitrary amount. For this purpose, the heat generation source is not limited to the diaphragm motor 222. For example, as described in a known technique (Japanese Laid-Open Patent Publication (kokai) No. 2017-198768), the temperature of the optical element may be increased using heat of other heat generating portions such as the battery 120 and/or the main substrate 130.

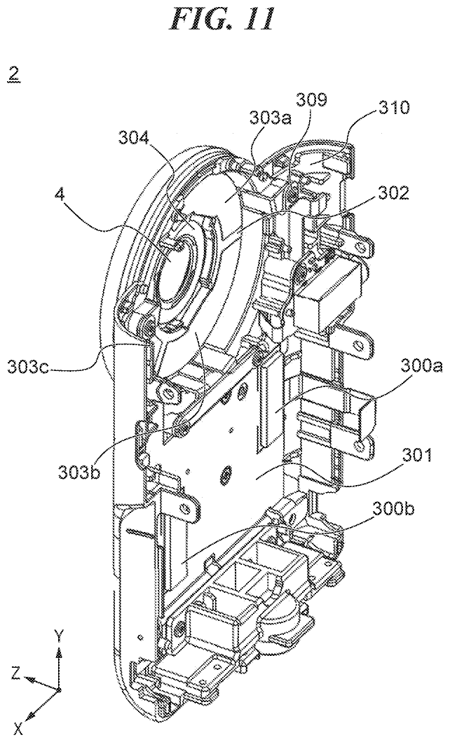

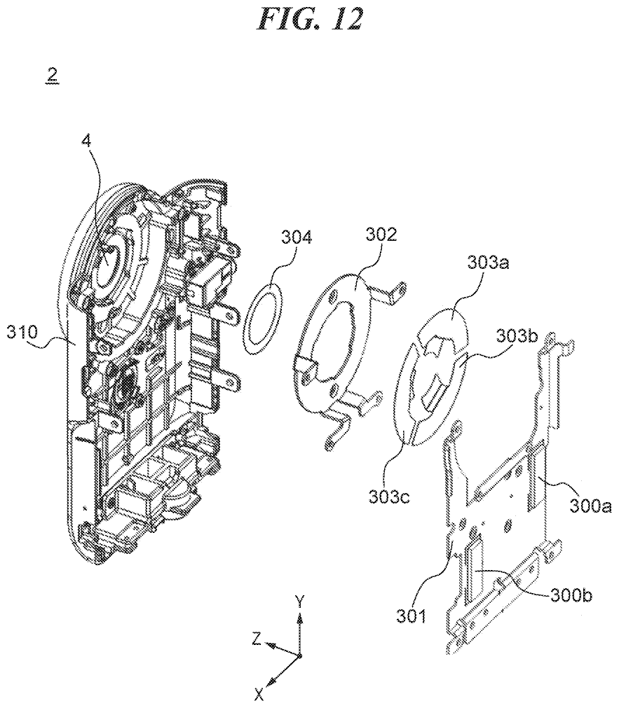

In the present embodiment, the temperature of second group lens L2 and/or the temperature in the vicinity of second group lens L2 is increased for the purpose of suppressing the condensation generated on the second group lens L2. The present invention can also be applied to other optical elements. That is, an optical element other than the second group lens L2 may be a target of suppressing the condensation. For example, an optical element constituting a portion of the exterior of the camera 1, or an optical element exposed from the exterior, such as the protective glass 4 (FIG. 1A), may be heated by a heat generation source. Accordingly, the condensation generated on the optical element other than the second group lens L2 may be suppressed. A configuration for increasing the temperature of the protective glass 4 will be described with reference to FIGS. 11 and 12.

FIG. 11 is a rear perspective view of the front surface cover 2. FIG. 12 is a rear exploded perspective view of the front surface cover 2. The front surface cover 2 is configured to transfer heat generated by the battery 120 to the vicinity of protective glass 4. The heat transfer member that transfers the heat to the protective glass 4 includes a fourth heat transfer elements 300a and 300b, a fifth heat transfer element 301, a sixth heat transfer element 302, a seventh heat transfer elements 303a, 303b, and 303c, and an eighth heat transfer element 304.

The front surface cover 2 includes a front surface exterior member 310 on a most +Z side in the front surface cover 2. The fourth heat transfer elements 300a and 300b are made of a flexible member having a high thermal conductivity. The fifth heat transfer element 301 is fixed to the front surface exterior member 310 with screws at a plurality of fastening places. The fourth heat transfer elements 300a and 300b are in contact with the battery 120, and transfer the heat of the battery 120 to the fifth heat transfer element 301.

The fifth heat transfer element 301 is fixed to the front surface exterior member 310 together with the sixth heat transfer element 302 by a screw 309 (FIG. 11), at some of the fastening places. The fifth heat transfer element 301 and the sixth heat transfer element 302 are in contact with each other at least at the fastening portion fixed by the screw 309. With this arrangement, the heat of the fifth heat transfer element 301 is transferred to the sixth heat transfer element 302. The fifth heat transfer element 301 and the sixth heat transfer element 302 are made of, for example, an aluminum sheet.

The seventh heat transfer elements 303a, 303b, and 303c transfer the heat of the sixth heat transfer element 302 to the eighth heat transfer element 304. Each of the seventh heat transfer elements 303a, 303b, and 303c is made of a heat conductive sheet member, for example, a graphite sheet. By configuring the plurality of heat transfer elements with the heat conductive sheet member in this manner, it is possible to arrange the plurality of heat transfer elements in a narrower space, and it is possible to transfer the heat to a position as close as possible to the protective glass 4.

The seventh heat transfer elements 303a, 303b, and 303c have the same shape. The eighth heat transfer element 304 is made of a copper foil tape. The eighth heat transfer element 304 has an annular shape, is in contact with the seventh heat transfer elements 303a, 303b, and 303c, and is in contact with the front surface exterior member 310 in the vicinity of the protective glass 4. Since the eighth heat transfer element 304 has the annular shape, the heat can be substantially uniformly transferred to the protective glass 4 in the circumferential direction of the protective glass 4. As a result, it possible to suppress a degradation of optical performance due to a temperature gradient in the protective glass 4.

As described above, the protective glass 4 is heated using the heat of the battery 120, which makes it possible to suppress the condensation on the protective glass 4.

In addition, the temperature of the second group lens L2 may be increased using the heat generated by the diaphragm motor 222, and at the same time, the temperature of the protective glass 4 and/or other optical elements may be increased using the heat generated by the battery 120 or the like. Accordingly, the condensation can be suppressed in the entire imaging optical system of the camera 1.

In general, there is an event that when an optical element (protective glass 4 or the like) forming an exterior is heated, an atmosphere inside a housing is heated, and as a result, the condensation is likely to be generated on an optical element (second group lens L2 or the like) contained in an image pickup apparatus. On the other hand, in the present embodiment, it is possible to appropriately suppress the condensation on the second group lens L2, by increasing the temperature of the second group lens L2 using the heat of the diaphragm motor 222 while warming the protective glass 4 to suppress the condensation on the protective glass 4.

According to the present embodiment, the heat of the diaphragm motor 222 is transferred to the second group lens L2 by the heat transfer member 235 having the higher thermal conductivity than that of the second group base plate 231 holding the second group lens L2. The diaphragm motor 222 is a heat generation source of which a heat generation amount is capable of being controlled. As a result, since a degree of the heat transfer to the second group lens L2 can be made variable, the second group lens L2 can be appropriately warmed. Therefore, the condensation on the optical element (second group lens L2) can be appropriately suppressed.

In addition, the second group lens L2 is contained in the exterior (covers 2, 8 and 19) of the camera 1, and the heat of diaphragm motor 222 is transferred to the second group lens L2 by the heat transfer member 235 having the higher thermal conductivity than that of the second group base plate 231 holding the second group lens L2. Accordingly, it is possible to suppress the condensation on the second group lens L2 due to warming of the atmosphere in the camera 1. For example, as described with reference to FIGS. 10 and 11, even if the atmosphere is warmed by adopting the configuration for warming the optical element (protective glass 4) constituting a portion of the exterior, the temperature of the second group lens L2, which is the optical element contained in the exterior, and the periphery of the second group lens L2 are also increased, thereby the generation of the condensation on the second group lens L2 can be suppressed. Therefore, the condensation generated on the optical element (second group lens L2) can be appropriately suppressed.

Since the diaphragm motor 222 and the second group lens L2 are contained in a common unit (lens barrel unit 200), the second group lens L2 can be warmed with a simple configuration even if there is a temperature difference between the inside and outside of the unit.

The second heat transfer element 235b is disposed so as to surround the periphery of the second group lens L2. With this arrangement, the heat is substantially uniformly transmitted to the second group lens L2 in a circumferential direction, and degradation of optical performance due to a temperature gradient in the second group lens L2 can be suppressed.

In addition, since the first heat transfer element 235a includes the portion connected to the diaphragm motor 222 and the portion fixed to the member holding the diaphragm motor 222, it is possible to reduce a size of the lens barrel unit 200 (eventually, the camera 1) and the number of components.

In addition, the elastic member 236 biases both the second heat transfer element arm portion 235b-1 and the third heat transfer element 235c in a direction in which the second heat transfer element arm portion 235b-1 and the third heat transfer element 235c are in contact with each other, which makes it possible to improve efficiency of heat transfer between the second heat transfer element arm portion 235b-1 and the third heat transfer element 235c.

In addition, the CPU 401 controls the heat generation amount of the diaphragm motor 222 according to at least one of the currently set shooting mode, the execution history of the shooting mode, the environment information, the obtainment history of the environment information, the remaining battery level, the battery consumption amount, and the state of the diaphragm motor 222. Accordingly, the condensation on the second group lens L2 can be more appropriately suppressed.

It should be noted that the heat transfer member 235 only needs to be thermally connected to the diaphragm motor 222 and the second group lens L2. Therefore, the heat transfer member 235 may be in direct contact with the second group lens L2. Alternatively, the heat transfer member 235 may be in contact with the diaphragm base plate 221, which is a holding member holding the diaphragm motor 222, at the vicinity of the diaphragm motor 222.

It should be noted that an optical element constituting a portion of the exterior such as the protective glass 4 may also be heated by heat of a heat generation source of which a heat generation amount is capable of being controlled.

It should be noted that materials of the first to eighth heat transfer elements are not limited to those exemplified.

It should be noted that, in the present embodiment, “substantially” is not intended to exclude completeness. For example, “substantially at a center”, “substantially planar”, “substantially uniformly”, and “substantially sealed” are intended to include complete at a center, planar, uniform, and sealed, respectively.

### Other Embodiments

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2023-069176, filed Apr. 20, 2023, which is hereby incorporated by reference wherein in its entirety.

What is claimed is:

1. An image pickup apparatus comprising:
an optical element;
a heat generation source of which a heat generation amount can be controlled;
a holding member configured to hold the optical element; and
a heat transfer member having a thermal conductivity higher than a thermal conductivity of the holding member, and configured to transfer a heat of the heat generation source to the optical element.

2. An image pickup apparatus comprising:
an optical element contained in an exterior;
a heat generation source;
a holding member configured to hold the optical element; and
a heat transfer member having a thermal conductivity higher than a thermal conductivity of the holding member, and configured to transfer a heat of the heat generation source to the optical element.

3. The image pickup apparatus according to claim 1, wherein the optical element is contained in an exterior.

4. The image pickup apparatus according to claim 2, wherein a heat generation amount of the heat generation source is capable of being controlled.

5. The image pickup apparatus according to claim 1, wherein the heat transfer member is thermally connected to the heat generation source.

6. The image pickup apparatus according to claim 1, wherein the heat transfer member is in contact with the optical element or in contact with the holding member at a vicinity of the optical element.

7. The image pickup apparatus according to claim 1, wherein the heat transfer member includes a portion disposed so as to surround a periphery of the optical element.

8. The image pickup apparatus according to claim 7, wherein the portion disposed so as to surround the periphery of the optical element has an annular shape.

9. The image pickup apparatus according to claim 1, wherein the heat transfer member is made of metal.

10. The image pickup apparatus according to claim 1, wherein
the heat transfer member includes two or more heat transfer elements, and
the two or more heat transfer elements include a heat transfer element thermally connected to the heat generation source and a heat transfer element thermally connected to the optical element.

11. The image pickup apparatus according to claim 1, wherein
the heat transfer member includes two or more heat transfer elements, and
one of the two or more heat transfer elements includes a portion connected to the heat generation source and a portion fixed to a member holding the heat generation source.

12. The image pickup apparatus according to claim 1, wherein
the heat transfer member includes two heat transfer elements in contact with each other, and
the image pickup apparatus further includes a biasing member configured to bias the two heat transfer elements in a direction in which the two heat transfer elements are in contact with each other.

13. The image pickup apparatus according to claim 1, further comprising a controller,
wherein the controller controls the heat generation amount of the heat generation source.

14. The image pickup apparatus according to claim 13, wherein the controller controls the heat generation amount of the heat generation source by changing a voltage to be applied to the heat generation source.

15. The image pickup apparatus according to claim 13, wherein the controller controls the heat generation amount of the heat generation source according to a shooting mode.

16. The image pickup apparatus according to claim 13, wherein the controller controls the heat generation amount of the heat generation source according to an execution history of a shooting mode.

17. The image pickup apparatus according to claim 13, wherein the controller
obtains an environment information, and
controls the heat generation amount of the heat generation source according to the obtained environment information.

18. The image pickup apparatus according to claim 17, wherein the environment information includes information on at least one of a temperature, a humidity, and an atmospheric pressure.

19. The image pickup apparatus according to claim 17, wherein the controller controls the heat generation amount of the heat generation source according to an obtainment history of the environment information.

20. The image pickup apparatus according to claim 13, wherein the controller controls the heat generation amount of the heat generation source according to a remaining capacity of a battery or a consumption amount of the battery.

21. The image pickup apparatus according to claim 13, wherein the controller
detects a state of the heat generation source, and
controls the heat generation amount of the heat generation source according to the detected state of the heat generation source.

22. The image pickup apparatus according to claim 1, wherein the heat generation source is an actuator.

23. The image pickup apparatus according to claim 1, wherein the heat generation source and the optical element are contained in a common unit.

24. The image pickup apparatus according to claim 23, wherein the common unit is a lens barrel unit and the optical element is a lens.
